(19) United States
(12) Patent Application Publication
(10) Pub. No.: US 2017/0076308 A1
(43) Pub. Date: Mar. 16, 2017

(54) Referral Tracking App

(71) Applicant: TRUSTWAVE HOLDINGS, INC., Chicago, IL (US)

(72) Inventor: Michelle R.' (Couch) Pursell, Cedar Hills, UT (US)

(21) Appl. No.: 14/855,210

(22) Filed: Sep. 15, 2015

(51) Int. Cl. G06Q 30/02

(52) U.S. Cl. CPC G06Q 30/0214

(57) ABSTRACT

This customizable app is for referral tracking on multiple levels with special features such as automatic e-mail reminders, ability to track which referrals have been paid and which referrals are still owed and allows the app user to offer special incentives to generate leads. This app allows the user to keep track of where those referrals come from, who that person referred, as well as being able to pay for referrals & track how much each referral was paid. This app tracks on unlimited multiple levels of referrals so the user can easily see where the referral base started and see all the referrals that were generated by each new referral, and so on. This app tracks the name(s), company, business type, product line, sales made and referral fees paid, referrals fees still owed out, etc. It is completely customizable to the user's type of business for optimal functionality. This app also allows the user to offer special incentives to generate more referrals. The user can set up their app according to the rules & guidelines of their particular industry.

### REFERRAL TRACKER APP

Primary purpose of this customizable app is for referral tracking on multiple levels with special features such as automatic e-mail reminders, ability to track which referrals have been paid and which referrals are still owed and allows the app user to offer special incentives to generate leads.

### SEARCH RESULTS

Prior Patent search was completed and no similar patents were found.

### BACKGROUND OF THE INVENTION

Problem Solved

Many sales industries rely on referrals for new business. But the problem is keeping up with who referred who and when one referral refers another and that referral refers another, it's hard to keep track of where the referral base started. This app allows the user to keep track of where those referrals come from, who that person referred, as well as being able to pay for referrals & track how much each referral was paid. This app tracks on unlimited multiple levels of referrals so the user can easily see where the referral base started and see all the referrals that were generated by each new referral, and so on. This app tracks the name(s), company, business type, product line, sales made and referral fees paid, referrals fees still owed out, etc. It is completely customizable to the user's type of business for optimal functionality. This app also allows the user to offer special incentives to generate more referrals.

### DETAILED DESCRIPTION OF THE INVENTION

As stated above, this app allows the user to keep track of where those referrals come from, who that person referred, as well as being able to pay for referrals & track how much each referral was paid. This app tracks on unlimited multiple levels of referrals so the user can easily see where the referral base started and see all the referrals that were generated by each new referral, and so on. This app tracks the name(s), company, business type, product line, sales made and referral fees paid, referrals fees still owed out, etc. It is completely customizable to the user's type of business for optimal functionality. This app also allows the user to offer special incentives to generate more referrals.

### The Version of The Invention Discussed Here Includes

1. This app allows the user to keep track of where referrals come from, who that person referred,
2. Ability to pay for referrals & track how much each referral was paid.
3. This app tracks on unlimited multiple levels of referrals so the user can easily see where the referral base started and see all the referrals that were generated by each new referral, and so on.
4. This app tracks the name(s), company, business type, product line, sales made and referral fees paid, referrals fees still owed out, etc.
5. It is completely customizable to the user's type of business for optimal functionality.
6. This app also allows the user to offer special incentives to generate more referrals.

### Relationship Between The Components

One app which is customizable to the user's needs offering versatility & functionality to help almost any sales type of business to track and pay referrals to help the user's business grow. The user can set up their app according to the rules & guidelines of their particular industry.

### How The Invention Works

Users download the Referral Tracker App for a fee. The User can customize their app to fit the needs of their particular business through selecting options from the set up menus.

### How To Make The Invention

The Referral Tracker App software will need to be created by a Software Engineer and/or Programmer. Apple, Google, Android will each need to approve the app to be sold on their systems. Once approved, the App will go live and be offered for purchase to the public.

### How To Use The Invention

The user pays the required fee and downloads the app to their phone, tablet, computer, etc. The user will need to go through the set up process to customize the app to their needs using the menu options in the set up portion of the program. Once set up, the user is ready to start using the app.

1. (canceled)

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. The customizable Referral Tracking App further comprising where a customizable multi-dimensional cloud based stored medium to be used by almost any business to track & pay for referrals on multiple levels.
claim #13 comprising of a customizable referral app where people from any business type can track referrals on multiple levels and their referrals can track referrals and their referrals and so on. (multi-level)
As in claim #13, the user can track how much referral money the user has paid and how much the user owes.
As in claim #13, further including & comprising of the ability to allow the user to send a reminder or request immediately to their referral sources for additional referrals.
As in claim #13, further including & comprising of Referral tracking ideas or suggestions made easy for various companies giving each ideas comprising of car companies, Real Estate agencies, restaurants, personal vendors, solar/security system companies, Sales, medical equipment sales, contractors, etc!
As in claim #13, further including, This app comprises of the ability to track birthdays or anniversaries or to send out incremental reminders or thank you notices automatically.
As in claim #13, This app allows the user to keep track of where referrals come from, who that person referred.
As in claim #13, This app comprises of the ability to track on unlimited multiple levels of referrals so the user can easily see where the referral base started and see all the referrals that were generated by each new referral, and so on.
As in Claim #13, this app comprises of the ability for the user to track the name(s), company, business type, product line, sales made and referral fees paid, referrals fees still owed out, etc.
As in Claim #13, This app comprises of a completely customizable medium to the user's type of business for optimal functionality.
As in Claim #13, This app comprising of the ability to allow the user to offer special incentives to generate more referrals.
